(19) United States
(12) Patent Application Publication
(10) Pub. No.: US 2012/0160830 A1
(43) Pub. Date: Jun. 28, 2012

(54) COOKING APPLIANCE

(75) Inventor: Hermann Bronstering, Wadersloh (DE)

(73) Assignee: MIELE & CIE. KG, Guetersloh (DE)

(21) Appl. No.: 13/323,839

(22) Filed: Dec. 13, 2011

(30) Foreign Application Priority Data
Dec. 23, 2010 (EP) 10 016 015.9

(51) Int. Cl. H05B 6/12

(52) U.S. Cl. 219/620

(57) ABSTRACT

A cooking appliance includes a cooking chamber, a heating source configured to heat the cooking chamber and a door for closing the cooking chamber. When the door is in a closed position an electromagnetically effective passage area from the cooking chamber to outside the cooking chamber is sized so as to substantially reduce an escape of electromagnetic radiation.

### CROSS REFERENCE TO RELATED APPLICATION

This application claims priority to European Patent Application No. 10 016 015.9, filed Dec. 23, 2010, which is hereby incorporated by reference herein in its entirety.

### FIELD

The present invention relates to a cooking appliance including a heatable cooking chamber and a door for closing the cooking chamber.

### BACKGROUND

Cooking appliances are continuously under development to make the preparation of food as easy and convenient as possible for the user. To this end, cooking appliances are provided, inter alia, with many assistance features intended to make the preparation of food easier and improve cooking results.

For example, thermometers have become known which are configured as a skewer and are either available as an accessory or even integrated in the appliance. Such thermometers may, for example, be inserted into a large piece of meat in order to measure the core temperature during cooking. This allows the user to easily determine the point at which the desired degree of cooking has been reached, since different levels of doneness can be distinguished, for example, by the core temperature.

In order to make the measured temperature available to a user in an effective and simple manner, the temperature may, for example, be displayed on the display of the cooking appliance. To this end, the temperature skewer may have a cable connected to the cooking appliance.

A temperature skewer connected by a cable to the cooking appliance may possibly reduce the ease of use for the user because, for example, the skewer cannot be easily taken to the sink for cleaning. Moreover, the cable may be perceived as disturbing by the user in cases where it may be in the way when placing food in the cooking chamber or removing it.

Therefore, there have also been described radio skewers which transmit the measured temperature to the cooking appliance by means of electromagnetic waves. In this way, the core temperature of a food can be wirelessly transmitted to a user; i.e., displayed on a display of a cooking appliance.

However, there are certain limits to be observed for the transmission via electromagnetic waves because otherwise other devices may in some cases be negatively affected. In the meantime, wireless data transfer has become an established method and, therefore, electromagnetic waves are used by many devices. Therefore, such radio skewers must comply with specific standards and legal requirements in order to be approved for private use.

When using radio skewers, radiation may leak from the cooking chamber, because despite the fact that the oven chamber opening is closed by a door, electromagnetic radiation may still escape in this region under certain circumstances.

### SUMMARY

In an embodiment the present invention provides a cooking appliance including a cooking chamber, a heating source configured to heat the cooking chamber, and a door for closing the cooking chamber. When the door is in a closed position an electromagnetically effective passage area from the cooking chamber to outside the cooking chamber is sized so as to substantially reduce an escape of electromagnetic radiation.

### BRIEF DESCRIPTION OF THE DRAWINGS

Exemplary embodiments of the present invention are described in further detail below with reference to the drawings, in which:

FIG. 1 is a highly schematic perspective view of a cooking appliance designed as a stand-alone unit;

FIG. 2 is a highly schematic perspective view of a cooking appliance designed as a built-in unit;

FIG. 3 is a highly schematic cross-sectional view of a cooking appliance according to an embodiment of the present invention;

FIG. 4 is a schematic view of the area of the cooking chamber of a cooking appliance;

FIG. 5 is a highly schematic view of a sealing device;

FIG. 6 is a schematic view showing another embodiment of a sealing device; and

FIG. 7 is highly schematic view showing a portion of a sealing device designed as a spring steel seal, shown attached to a cooking appliance according to the present invention.

### DETAILED DESCRIPTION

In an embodiment, the present invention provides a cooking appliance in which electromagnetic radiation can be better prevented from escaping from the cooking chamber.

A cooking appliance according to an embodiment of the present invention is designed, in particular, as a baking oven and includes at least one cooking chamber and at least one door for closing the cooking chamber. The at least one cooking chamber is heatable by at least one heating source and closable by the at least one door for closing the cooking chamber. Suitable methods for heating the cooking chamber include, in particular, top heat and/or bottom heat, convection mode operation and/or a broiling function. When the cooking chamber door is closed, an electromagnetically effective passage area from the cooking chamber to the outside is designed to be so small that the escape of electromagnetic radiation is significantly reduced.

Specifically, the free cross-sectional passage area is configured to significantly reduce the electromagnetic radiation in a relevant region. Thus, in particular, frequencies of, for example, wireless core temperature probes or radio skewers cannot escape from the cooking chamber through the free cross-sectional passage area. It is particularly advantageous to reduce the escaping radiation by at least 50%, preferably by 90%, and particularly preferably by 99%.

A cooking appliance designed in this way offers many advantages. One significant advantage is that the escaping electromagnetic radiation generated, for example, by a radio skewer adapted to measure the core temperature of a food item is significantly reduced in a cooking appliance according to the present invention. This makes it easier to comply with the limits stipulated by specific directives for the escape of electromagnetic waves.

In addition, this also prevents other devices from being affected in an undesired manner by escaping electromagnetic radiation. Conversely, however, it is also not possible for electromagnetic waves in the relevant region to enter from outside into the cooking chamber, which ensures reliable operation of, for example, a radio skewer.

The free cross-sectional passage area can preferably be minimized by making the gap between the at least one cooking chamber door and the opening of the at least one cooking chamber as small as possible. In particular, it is advantageous for the gap dimensions to be less than 5 mm, and preferably less than 1 mm. However, smaller and larger gap dimensions may also be suitable and conceivable, depending on the relevant wavelength.

Preferably, a free passage area that is possibly too large is reduced by means of a suitable sealing device. To this end, at least one sealing device may be provided in the gap between the at least one cooking chamber door and the opening of the at least one cooking chamber so as to reduce the effective cross-sectional area of passage. Preferably, this sealing device is suitable and adapted for blocking electromagnetic waves.

In preferred embodiments, the at least one sealing device is at least partially composed of an electrically conductive material. The makes it possible to effectively reduce or even completely prevent the escape of electromagnetic radiation.

Preferably, the sealing device is at least partially coated or vapor-deposited with an electrically conductive material. A sealing device designed in this way also reliably prevents electromagnetic waves from escaping from the cooking chamber.

In preferred embodiments, the sealing device is at least partially composed of conductive silicone. This embodiment is advantageous because previously installed silicone seals can simply be replaced with a conductive silicone seal.

Another preferred embodiment is a sealing device in the form of a spring steel seal. A seal designed in this way can also be effectively used to prevent escape of electromagnetic radiation from the cooking chamber.

Preferably, the sealing device may also be composed of at least one sealing unit and at least one electrically conductive unit. The sealing device used may, for example, be a glass fiber hose in which, for example, a wire mesh is arranged as the electrically conductive unit. The glass fiber hose is in particular also suitable for very high temperatures, such as occur, for example, during pyrolytic cleaning.

Other electrically conductive units may also be advantageously used for such a sealing unit. Suitable and preferred examples include a spring, a knitted wire fabric, a conductive rod, or electrically conductive silicone.

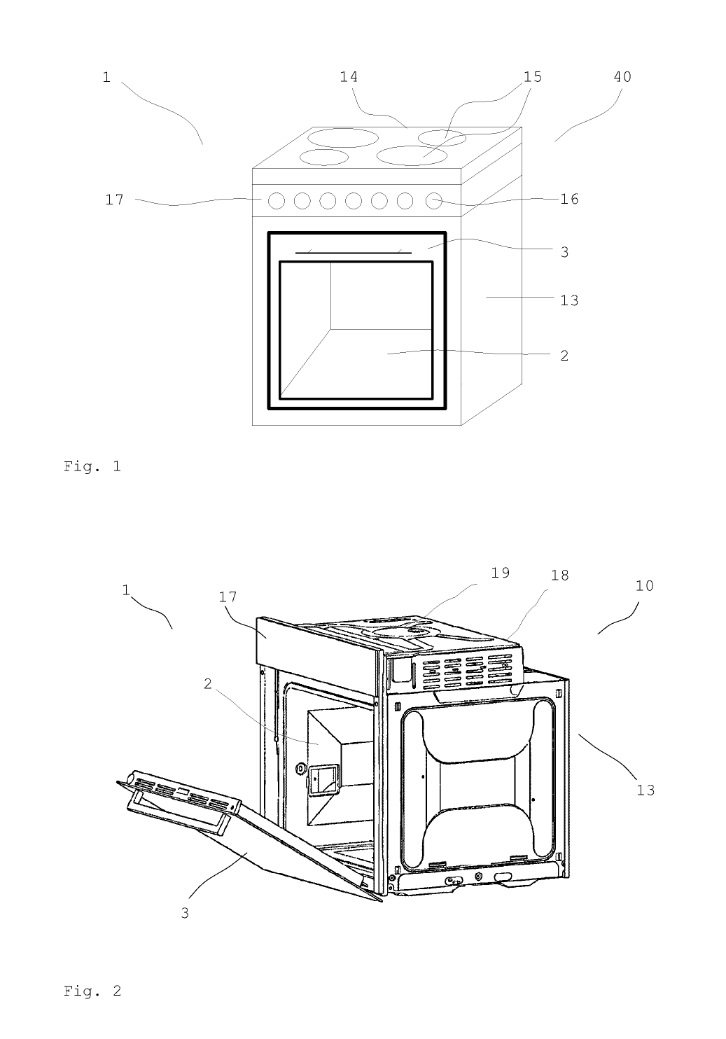

FIG. 1 shows, in a highly perspective view, a cooking appliance 1 according to the present invention, which is here designed as a range 40 and stand-alone unit. Cooking appliance 1 includes a housing 13 provided with a cooking chamber 2 which is closable by a door 3. When door 3 is open, a food product to be cooked can be placed in cooking chamber 2. The food can then be cooked in cooking chamber 2 by means of a heating source 4. In particular, this can be suitably done using top heat and/or bottom heat, a convection function and/or a broiling function.

On range 40, there is provided a cooktop 14 divided into a plurality of cooking zones 15. The desired settings for a cooking process can be entered via a number of controls 16 on a control panel 17. Control panel 17 may further include an indicating device such as, for example, a display for displaying the current state of cooking appliance 1 and the selected parameters.

FIG. 2 shows, in a schematic perspective view, a cooking appliance 1 which, in the present case, is designed as a backing oven 10 suitable for built-in installation. The housing 13 enclosing cooking chamber 2 may, in turn, be surrounded by the body of a piece of furniture. In FIG. 2, cooking appliance 1 is shown with door 3 in a half-open position. Above cooking chamber 2, there is room for a control unit 18. The electronics of control unit 18 are cooled via an appliance cooling system 19.

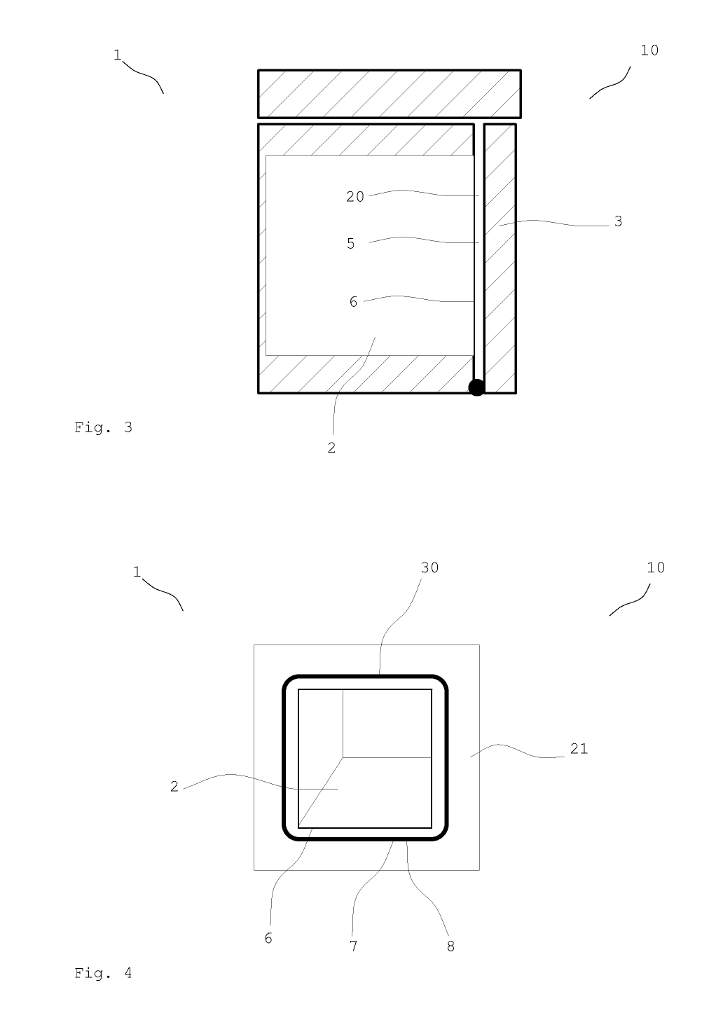

FIG. 3 shows a highly schematic cross-sectional view through a cooking appliance 1 according to an embodiment of the present invention which, again, is designed as a baking oven 10. In the exemplary embodiment shown here, free cross-sectional passage area 20 is so small that the escape of electromagnetic waves from cooking chamber 2 is significantly reduced. To this end, gap 5 between the closed cooking chamber door 3 and cooking chamber opening 6 is made so small that electromagnetic waves, which occur, for example, when using radio skewers for determining the core temperature of foods, are effectively prevented from escaping from cooking chamber 2.

This facilitates compliance with specified limit values, so that other devices responsive to electromagnetic waves are not affected by the radio skewer in cooking chamber 2.

However, in certain circumstances, gap 5 between the closed cooking chamber door 3 and cooking chamber opening 6 cannot be made small enough, or it may be desired that appliances having a gap 5 that is too large for the particular wavelength be retrofitted such that electromagnetic waves cannot escape from cooking chamber 2. In such cases, in particular, a sealing device 30 can be suitably used to reduce gap 5 in such a way that the effective cross-sectional passage area 20 is reduced to a suitable size.

To this end, sealing device 30 should preferably be composed of a conductive material 7. FIG. 4 shows, in a schematic detail view, the area of the exposed cooking chamber opening 6 of a baking oven 10 according to the present invention. In the exemplary embodiment shown here, a sealing device 30 made of conductive silicone extends around cooking chamber opening 6 along oven front 21. When door 3 is closed, this sealing device 30 reduces gap 5 to a free cross-sectional passage area 20 so small that electromagnetic waves can no longer escape from cooking chamber 2.

A sealing device 30 made of conductive silicone 8 is, in particular, also suitable for retrofitting appliances having conventional silicone seals so as to prevent escape electromagnetic waves also in such appliances.

It is also possible to make a sealing device 30 from non-conductive material which is subsequently coated and/or vapor-deposited with a conductive material 7.

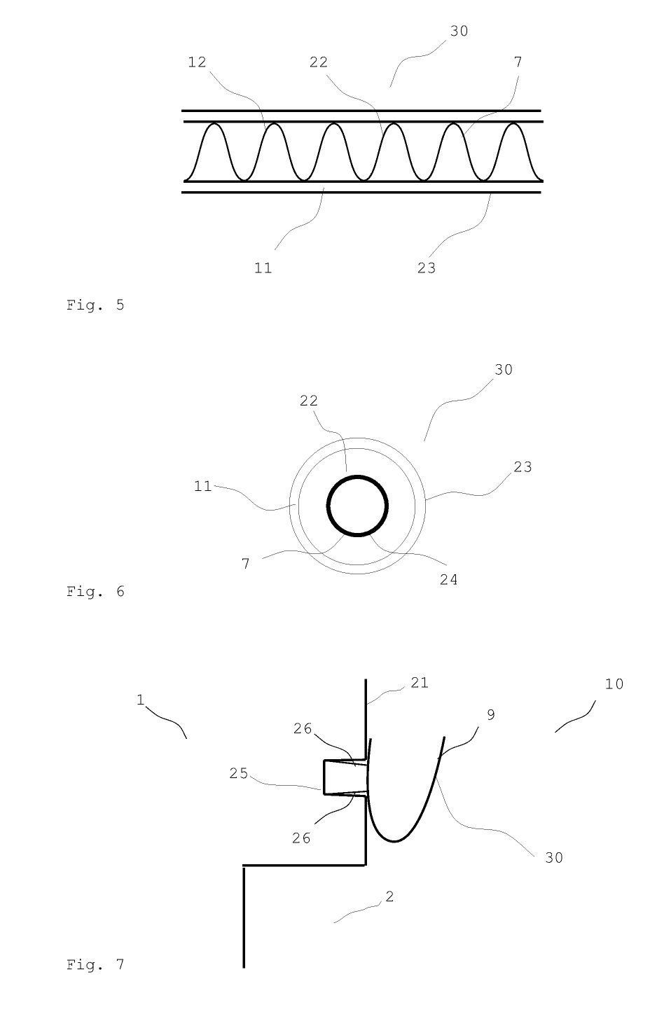

FIG. 5 shows a schematic longitudinal sectional view through a sealing device 30 including a sealing unit 11 and an electrically conductive unit 12. In the exemplary embodiment shown here, sealing unit 11 is formed by a glass fiber hose 23. A sealing unit 11 designed in this way is, in particular, also suitable for very high temperatures, such as occur, for example, during pyrolytic cleaning. Other materials are also suitable for sealing unit 11. In the exemplary embodiment shown here, electrically conductive unit 12 is formed by a spring 22 made of electrically conductive material 7.

In FIG. 6, a different design of a sealing device 30 is shown in a transverse cross-sectional view. Here, too, sealing unit 11 is formed by a glass fiber hose 23. However, electrically conductive unit 12 is implemented as a conductive rod 24 arranged in glass fiber hose 23. In order to achieve a suitable shape of this sealing device 30, rod 24 may, in particular, also be made of a conductive material 7 that can be bent or formed into a suitable shape.

FIG. 7 shows another embodiment of a sealing device 30 for reducing the gap 5 shown in FIG. 1. Here, sealing device 30 is provided by a spring steel seal 9, which is mounted in a groove 25 in front 21 of cooking appliance 1. For this purpose, in the example shown, spring steel seal 9 includes fastening means 26. Gap 5 between the closed door 3 and cooking chamber opening 6 is then effectively sealed by spring steel seal 9 against escape of electromagnetic waves.

It is within the ability of one skilled in the art to modify the exemplary embodiments described in a manner not presented in order to achieve the desired effects without departing from the scope of the present invention.

### LIST OF REFERENCE NUMERALS

1 cooking appliance
2 cooking chamber
3 door
4 heating source
5 gap
6 cooking chamber opening
7 electrically conductive material
8 conductive silicone
9 spring steel seal
10 baking oven
11 sealing unit
12 electrically conductive unit
13 housing
14 cooktop
15 cooking zone
16 controls
17 control panel
18 control unit
19 appliance cooling system
20 cross-sectional passage area
21 front
22 spring
23 glass fiber hose
24 rod
25 groove
26 fastening means
30 sealing device
40 range

What is claimed is:

1: A cooking appliance comprising:
at least one cooking chamber;
at least one heating source configured to heat the at least one cooking chamber; and
at least one door for closing the at least one cooking chamber,
wherein when the door is closed, an electromagnetically effective passage area from the at least one cooking chamber to outside the at least one cooking chamber is sized so as to substantially reduce an escape of electromagnetic radiation.

2: The cooking appliance recited in claim 1, wherein a gap between the at least one door and an opening of the at least one cooking chamber is minimized.

3: The cooking appliance recited in claim 1, further comprising at least one sealing device disposed in a gap between the at least one door and an opening of the at least one cooking chamber, the at least one sealing device being configured so as to reduce the electromagnetically effective passage area and being configured to block electromagnetic waves.

4: The cooking appliance recited in claim 3, wherein the at least one sealing device includes an electrically conductive material.

5: The cooking appliance recited in claim 3, wherein the at least one sealing device is at least partially coated with an electrically conductive material.

6: The cooking appliance recited in claim 3, wherein the at least one sealing device is at least partially vapor-deposited with an electrically conductive material.

7: The cooking appliance recited in claim 4, wherein the at least one sealing device includes conductive silicone.

8: The cooking appliance recited in claim 5, wherein the at least one sealing device includes conductive silicone.

9: The cooking appliance recited in claim 6, wherein the at least one sealing device includes conductive silicone.

10: The cooking appliance recited in claim 3, wherein the at least one sealing device is a spring steel seal.

11: The cooking appliance recited in claim 3, wherein the at least one sealing device includes at least one sealing unit and at least one electrically conductive unit.

12: The cooking appliance recited in claim 1, wherein the cooking appliance is a baking oven.
